(19) United States
(12) Patent Application Publication
(10) Pub. No.: US 2007/0186770 A1
(43) Pub. Date: Aug. 16, 2007

(54) Natural Gas Vapor Recovery Process System

(76) Inventors: Rodney T. Heath, Farmington, MN (US); Forrest D. Heath, Katy, TX (US); Gary Heath, Farmington, MA (US)

Correspondence Address: PEACOCK MYERS, P.C., 201 THIRD STREET, N.W., SUITE 1340, ALBUQUERQUE, NM, 87102, US

(21) Appl. No.: 11/677,985

(22) Filed: Feb. 22, 2007

Related U.S. Application Data
(63) Continuation-in-part of application No. 11/456,001, filed on Jul. 6, 2006.
Application No. 11/456,001 is a continuation-in-part of application No. 11/234,574, filed on Sep. 22, 2005.
(60) Provisional application No. 60/612,278, filed on Sep. 22, 2004.

(51) Int. Cl. B01D 53/14; B01D 21/00

(52) U.S. Cl. 95/179; 95/166; 210/801

(57) ABSTRACT

The present invention provides for a natural gas well vapor recovery processing system and method comprising recovering gaseous hydrocarbons to prevent their release into the atmosphere including providing a method for preventing the gaseous hydrocarbons from returning to a liquid state.

### CROSS-REFERENCE TO RELATED APPLICATIONS

This is a continuation-in-part application of U.S. patent application Ser. No. 11/456,001, titled “Vapor Recovery Process System” filed Jul. 6, 2006 which in turn is a continuation-in-part application of U.S. patent application Ser. No. 11/234,574, titled “Vapor Process System” filed Sep. 22, 2005, which claims the benefit of the filing of U.S. Provisional Patent Application Ser. No. 60/612,278, entitled “Vapor Process System”, filed on Sep. 22, 2004, and the specifications and claims of those applications are incorporated herein by reference.

### BACKGROUND OF THE INVENTION

1. Field of the Invention (Technical Field):

The present invention relates to vapor recovery processing systems for use with natural gas wells. The invention comprises a pumping system used with an engine instead of plunger lifts and can be used to remove evolved gases from hydrocarbon liquids to storage at or near atmospheric pressure.

2. Background Art:

In addition to producing natural gas, many natural gas wells produce hydrocarbon liquids and water. The liquids, hydrocarbons, and water are separated from the flowing natural gas by a separator installed in the line carrying the flowing gas stream. The inline separator may operate at pressures as high as 1,500 psig or as low as 30 psig. The inline separator may separate the separated liquids into hydrocarbon and water components. The separated water is dumped to disposal, and the separated hydrocarbons are dumped to storage. The storage for the separated hydrocarbons is generally a steel tank or tanks with each tank having a capacity of 200 to 500 barrels. The storage tanks may operate at pressures as high as 16 ounces to as low as atmospheric pressure.

An intermediate pressure separator is often used on natural gas wells that are operating at elevated pressures (150 to 1,500 psig). The intermediate pressure separator may operate at pressures of 125 to 25 psig. The intermediate pressure separator receives the total separated liquid from the inline separator. The intermediate pressure separator separates the liquid into its components, hydrocarbons and water. As described above, the water is dumped to disposal and the hydrocarbons are dumped to storage. As a result of the reduction of pressure, the intermediate pressure separator also releases most of the entrained natural gas from the separated hydrocarbons. Without a means to recover the entrained natural gas or a means designed to collect and burn the entrained natural gas, the entrained natural gas released in the intermediate pressure separator will be vented to the atmosphere and wasted. In most systems designed to collect and burn the entrained natural gas, the heat energy released by burning the natural gas is wasted to the atmosphere. A means is needed to prevent entrained natural gas from being released to the atmosphere.

Because of the reduction in pressure from the intermediate pressure separator to the storage tank, the liquid hydrocarbons dumped to the storage tanks will release additional entrained natural gas, and any component of the natural gas liquids that is not stable at the storage tank pressure and temperature will begin to evolve from the hydrocarbon liquids and change from a liquid to a gaseous state. The changing in the storage tank of hydrocarbon liquids from a liquid to a gaseous state is commonly referred to as “weathering”. Again, without a system to either recover or burn the gases released from the hydrocarbon liquids dumped to the storage tank, the gases will vent to the atmosphere and be wasted. The gases released from the storage tank are a high BTU value of approximately 3,000 BTU per cubic foot compared to the standard of 1,000 BTU per cubic foot required for residential gas. A means is needed to prevent gases released from liquid hydrocarbons from being released to the atmosphere.

For many years, systems have been made available to collect the gaseous hydrocarbons that are released from liquid hydrocarbons separated at elevated pressures and then transferred to storage tanks operating at near atmospheric pressure. In addition to operating problems that can occur with the currently available recovery systems, the biggest problem that has limited their application has been capital cost, and the systems have generally been applied to gas wells that have operated at pressures of 250 psig or less and that have produced volumes of hydrocarbon liquids in the range of 100 barrels per day or more.

Natural gas wells that can produce 100 barrels per day or more of hydrocarbon liquids do not generally require any type of artificial lift to lift the liquid hydrocarbons to the surface. In most cases, smaller volume natural gas wells do require artificial lift to lift the liquid hydrocarbons to the surface. A widely used artificial lift systems is called a “plunger lift”. The plunger is a metal device that falls to the bottom of the natural gas well tubing while the gas flow is shut off at the surface. The plunger remains at the bottom of the tubing for a period of time while the gas well builds up enough pressure to provide enough gas flow to bring to the surface the plunger and the load of liquid hydrocarbons the plunger is lifting. When the gas well is again opened, the plunger and liquid hydrocarbons rise to the surface. Often, the liquid hydrocarbons arrive at the surface as a slug that is much larger than the normal hydrocarbon liquid production of the well. The liquid hydrocarbon slug can create a volume of flash and evolved gases that will overload the vapor recovery system.

On natural gas wells where the plunger lift or other types of artificial lift creates a slugging condition that overloads the vapor recovery system, a pumping system developed by Unico, Inc. (“Unico”) can be used to lift the produced liquid hydrocarbons to the surface. Up until now, pumping of natural gas wells has been avoided because of pumping problems. Some of the problems with pumping gas wells have been gas locking (a condition where the pumping barrel fills with gas and no fluid can be pumped), gas interference (a condition where the pumping barrel only partially fills with fluid each stroke of the pump), and fluid pounding (a condition where the downward stroke of the pump contacts the fluid in a less than fluid filled barrel). The Unico pumping system presents a solution to the problems of pumping gas wells by only pumping the amount of fluids the well is producing. Pumping only the amount of fluids the well is producing prevents “pump-off” (a condition where the well bore is pumped dry thereby allowing gas to enter the pump barrel). A method is needed to eliminate gas entering the pump barrel to eliminate the problems associated with pumping natural gas wells.

### BRIEF SUMMARY OF THE INVENTION

An embodiment of the present invention provides for a natural gas well vapor recovery processing system (referred to herein as “VRSA”) and method comprising recovering gaseous hydrocarbons to prevent their release into the atmosphere including providing a method for preventing the gaseous hydrocarbons from returning to a liquid state.

In one embodiment of the present invention, evolved gases are entrained at the vacuum port of an eductor into a fluid stream and compressed. The fluid flowing through the eductor discharges into an emissions separator where the compressed gases separate from the fluid, and the compressed gases flow to the outlet of the emissions separator to be further processed while the fluid falls to the bottom of the emissions separator. The fluid collects in the bottom of the emissions separator to provide a continuous closed circuit fluid feed to the suction of a circulating pump.

The emissions separator also receives entrained gas that evolves from hydrocarbon liquids when the liquids are separated from a flowing gas stream at higher pressure and dumped to the lower pressure of an intermediate pressure separator. In the emissions separator, the two gases mix to form a homogeneous mixture. The homogeneous gas mixture flows from the outlet of the emissions separator to the suction of a gas compressor where the gases are compressed to the pressure of the flowing gas stream. The compressed gases are discharged back into the flowing gas stream at the inlet to the inline separator where the compressed gases mix with the flowing gas stream to form, in the inline separator, a second homogeneous gaseous mixture. The second homogeneous gas mixture flows from the outlet of the inline separator to other processing or to points of sale.

Another embodiment provides for mixing a high BTU and vapor pressure gas with a lower BTU and vapor pressure gas flowing in the pipeline to reduce the BTU and partial pressure of the compressed gas while at the same time slightly raising the BTU and partial pressure of the flowing gas stream. Lowering the BTU and partial pressure of the compressed gases reduces the tendency of the gases evolved and recovered from the tank to return to a liquid state. Any of the compressed gases that return back to a liquid state prior to passing out of the inline separator are again separated and dumped back to the storage tank.

Thus, an embodiment of the present invention provides a method for preventing the release of natural gas in a natural gas well processing system from entering the atmosphere comprising, collecting evolved gases from a storage tank, entraining the evolved gases into a fluid stream, compressing the evolved gases and fluid stream, sending the evolved gases and fluid stream to an emissions separator, and separating the gases from the fluid for further processing. Preferably, the evolved gases are collected using a vacuum, and preferably, the method further comprises providing an eductor to create the vacuum and to entrain the gases into the liquid stream. The method preferably further comprises mixing a first compressed gas with a second compressed gas flowing in a pipeline, the second compressed gas having a BTU lower relative to the BTU of the first compressed gas to prevent gaseous hydrocarbons in the natural gas well processing system from entering a liquid state.

Another embodiment provides a method for preventing the release of gaseous hydrocarbons at a natural gas well processing system from entering the atmosphere, the method comprising providing an emissions separator, sending to the emissions separator the entrained gases that evolve form hydrocarbon liquids when the liquids are separated from a flowing gas stream at higher pressure and put in the lower pressure of an intermediate separator, sending the gaseous hydrocarbons to a compressor and compressing the gaseous hydrocarbons, and sending the compressed gaseous hydrocarbons to a flowing gas stream for further processing or point of sale.

Another embodiment provides a natural gas well processing system comprising a hydrocarbon storage tank, an eductor linked to the storage tank to receive gases that evolve in the storage tank, entrain said gases into a fluid stream, and compress the gases and said fluid stream, and an emissions separator linked to the eductor for receiving the evolved gases and fluid stream for separation of the gases from the fluid stream and for sending the gases out of the emissions separator for further processing.

Another embodiment provides a system for controlling engine speed of a natural gas well vapor recovery processing system to increase a vapor handling capacity of said vapor recovery system, said engine speed control system comprising an emissions separator comprising a pressure chamber and a vacuum chamber, a first pressure transducer in communication with the pressure chamber to sense a rise or fall of pressure in the pressure chamber, a computer in communication with the first pressure transducer and in communication with an engine to vary engine speed in response to a signal from the first pressure transducer, and a second pressure transducer located on a vapor collection line between a storage tank and the vacuum chamber, the second pressure transducer for sensing a rise in pressure in said vapor collection line, and the second pressure transducer in communication with the computer so that the computer varies the engine speed in response to a signal from the second pressure transducer.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a flow diagram of an embodiment of the invention;

FIG. 2 is a flow diagram of a modification of the embodiment of FIG. 1;

FIG. 3 is a schematic of a natural gas dehydrator system that may be combined with the embodiment of FIG. 1 or FIG. 2; and

FIG. 4 is a schematic of the present invention comprising engine speed control components.

### DETAILED DESCRIPTION OF THE INVENTION

The present invention provides a vapor recovery processing system (referred to herein as “VRSA”) and method. An embodiment comprises a pumping system to replace plunger lifts used on natural gas wells. For example, the pumping system such as that disclosed and marketed by Unico, Inc. (“Unico”) (or other appropriate) pumping system can be used with an engine such as that provided by Marathon Engine Systems (or other appropriate engine) to replace plunger lifts on natural gas wells. Replacing the plunger lift increases a well's production time by eliminating the lost production time associated with shutting down the well to allow the plunger to fall to the bottom as well as eliminating the lost production time required for the well to build up enough pressure to cause the plunger to rise to the surface. Often, the lost production time is greater than a well's production time. Besides increasing a well's production time, the Unico pumping system further increases a well's production by lowering the pressure the producing formation is producing against. The fluids produced by the well are pumped up through the tubing, and the gas is produced out the casing, eliminating the pressure deferential between the casing and tubing required to produce both the fluids and gas up through the tubing.

An embodiment of the present invention provides an economical system for use on natural gas wells that produce a small volume of hydrocarbon liquids (5 to 50 barrels per day), although the present invention can also be used for larger volumes. The system collects and returns the gaseous hydrocarbons to a gas stream flowing at 250 psig or less, the gaseous hydrocarbons released as a result of separating liquid hydrocarbons from the flowing gas stream and transferring to, and storing in, tanks, at near or atmospheric pressure, the separated liquid hydrocarbons.

In an embodiment of the present invention, an engine generator set such as, for example, a 7.5 horsepower engine generator set (e.g. a generator set such as supplied by Marathon Engine Company), is used to provide the power to operate the gas recovery system. The engine generator set powers electric motors (for example, two electric motors). One electric motor powers a circulating pump to provide fluid energy to power an eductor that creates a vacuum to collect evolved gases from the storage tanks. The evolved gases are entrained at the vacuum port of the eductor into the fluid stream and compressed to a maximum of, for example, 30 psig. The fluid flowing through the eductor discharges into an emissions separator where the compressed gases separate from the fluid and the compressed gases flow to the outlet of the emissions separator to be further processed while the fluid falls to the bottom of the emissions separator. The fluid collects in the bottom of the emissions separator to provide a continuous closed circuit fluid feed to the suction of a circulating (circulation) pump.

The emissions separator also receives entrained gas that evolves from hydrocarbon liquids when the liquids are separated from a flowing gas stream at higher pressure and dumped to the lower pressure of an intermediate pressure separator. On most installations, the intermediate pressure separator and the emissions separator operate at the same pressure (e.g. 30 psig or less), but on some installations it is desirable to use a back pressure to hold the intermediate pressure separator at a higher pressure than the operating pressure of the emissions separator. In the emissions separator, the two gases (one at, for example, approximately 3,000 BTU per cubic foot from the storage tanks and the other at, for example, approximately 2,000 BTU per cubic foot from the intermediate pressure separator) mix to form, for example, an approximately 2,500 BTU per cubic foot homogeneous mixture. The 2,500 BTU homogeneous gas mixture flows from the outlet of the emissions separator to the suction of a small capacity, conventional, reciprocating, gas compressor where the gases are compressed to the pressure of the flowing gas stream (e.g. 250 psig or less). The compressed gases are discharged back into the flowing gas stream at the inlet to the inline separator where the compressed gases mix with the flowing gas stream to form, in the inline separator, a second homogeneous gaseous mixture. The second homogeneous gas mixture flows from the outlet of the inline separator to other processing or to points of sale.

Mixing the relatively small volume of high BTU and vapor pressure gas (e.g., approximately 2,500 BTU per cubic foot compressed gas) with the larger volume of lower BTU and vapor pressure gas (e.g., approximately 1,000 BTU per cubic foot gas) flowing in the pipeline greatly reduces the BTU and partial pressure of the compressed gas while at the same time slightly raising the BTU and partial pressure of the flowing gas stream. Lowering the BTU and partial pressure of the compressed gases reduces the tendency of the gases evolved and recovered from the tank to return to a liquid state. Any of the compressed gases that return back to a liquid state prior to passing out of the inline separator are again separated and dumped back to the storage tank. The physical process of gases evolving from hydrocarbon liquids stored at low pressure, the gases being compressed to a higher pressure, then, after compression, the gases changing state from a gas back to a liquid, and, again, the liquid being dumped back to low pressure storage to begin evolving into a gas again, greatly increases the compressor horsepower required to recover evolved gases. The higher the flowing line pressure, the more gases that will be evolved when hydrocarbon liquids are separated from a flowing gas stream and then dumped from the higher pressure to a lower pressure Also, the higher the flowing line pressure, the greater is the tendency for the evolved gases from liquid hydrocarbons, dumped from a higher pressure to a lower pressure, to change from a gaseous state back to a liquid state when the gases are collected and compressed back to the higher pressure.

The tendency of hydrocarbon liquids to change state from liquids to gases and then back to liquid again can create what are commonly called “recycle loops”. At times, the recycle loops can become large enough to force the required compressor horsepower needed to recover the evolved gases to become infinite and a simple vapor recovery system cannot be used. The “Hero” system described in U.S. Pat. No. 4,579,565, was designed to address applications where simple vapor recovery was not practical.

Another object of the present invention is to provide a process that allows the use, with some modifications, of the previously described components of the simple vapor recovery system to collect the evolved gases from hydrocarbon liquids separated at pressures as high as, for example, 500 to 1,000 psig and then dumped to storage at, or near, atmospheric pressure. As previously described, without modifications to the process, the simple vapor recovery system can develop, at high flowing gas pressures, recycle loops that could cause the horsepower required by the recovery system to become infinite.

To decrease the tendency of gases evolved from hydrocarbon liquids separated at high pressure, dumped to storage at low pressure, collected at low pressure, and then, again, compressed back to high pressure to change state from a gas to a liquid, the previously described simple vapor recovery system is modified in the embodiment of the present invention described below.

In one embodiment, the collected volume of high BTU gas forming the suction volume of any stage of the reciprocating compressor is increased by as much as 5% to 10% by introducing lower BTU line gas from the inline separator into the volume of collected suction gas. Changing the partial pressure of the homogenous gas mixture, by introducing lower BTU line gas into the higher BTU suction gas, decreases the tendency of the higher BTU suction gas to change state from a gas to a liquid when the homogenous gas mixture is compressed and cooled. In another embodiment, the temperature between stages of compression of the homogenous gas mixture is controlled to maintain the suction temperature of each stage of compression at approximately 100 to 120 degrees Fahrenheit. Both embodiments can be combined in one system.

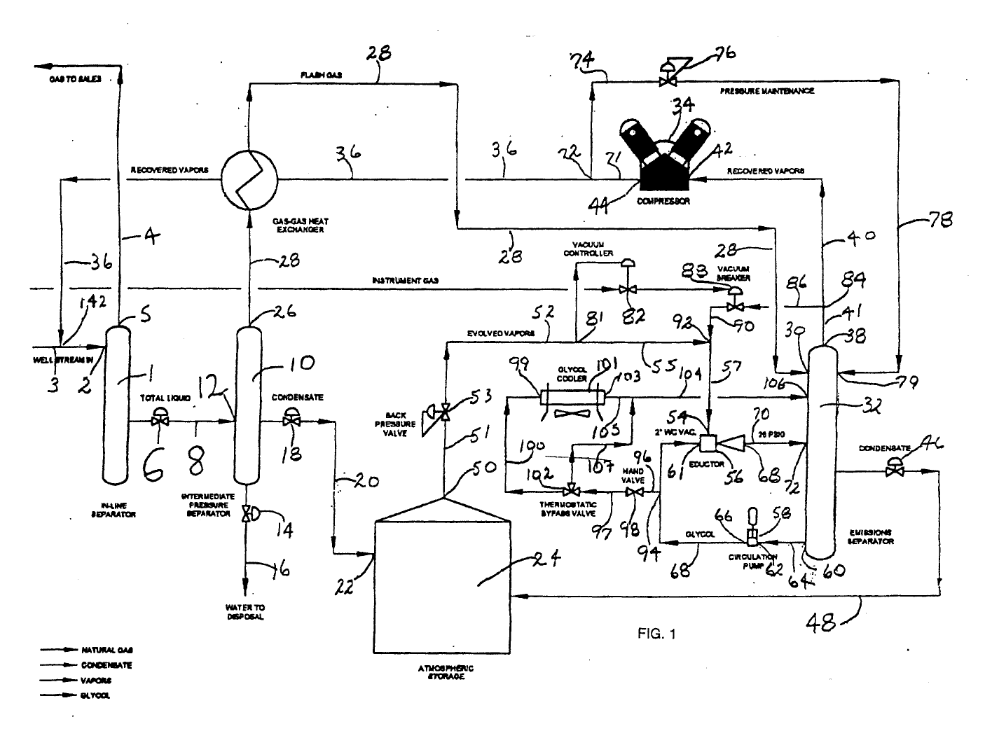

Turning now to the figures, FIG. 1 is a flow diagram of the vapor system which accomplishes decreasing the tendency of the higher BTU suction gas to change state from a gas to a liquid. Referring to FIG. 1, line 3 comprises a flowing natural gas stream. The flowing natural gas stream in line 3 enters inline separator 1 at inlet 2. While flowing through inline separator 1, the free fluids, liquid hydrocarbons and water, are separated from the flowing natural gas. The flowing natural gas exits inline separator 1 at exit 5 and flows through line 4 to sales or other processing.

The free fluids fall to the bottom of inline separator 1 and are dumped through valve 6 (valve 6 is actuated by a liquid level control (not shown)) and flow through line 8 to enter intermediate pressure separator 10 at inlet 12. The free fluids fall to the bottom of intermediate separator 10. In the bottom of intermediate separator 10, the free fluids are separated by a conventional weir system into the free fluids components, liquid hydrocarbons and water. The water is dumped by valve 14 (valve 14 is actuated by a liquid level control (not shown)) and flows through line 16 to disposal. The liquid hydrocarbons are dumped through valve 18 (valve 18 is actuated by a liquid level control (not shown)) and flow through line 20 to the inlet 22 of storage tank 24. The changes to the liquids being dumped from intermediate separator 10 to storage tank 24 are described below.

The gas that flashes as a result of the liquid hydrocarbons being dumped from the higher pressure of inline separator 1 to the lower pressure of intermediate separator 10 form a first body of homogeneous gas mixture which comprises water vapor, portions of natural gas that were entrained in the liquid hydrocarbons, and components of the liquid hydrocarbons which have flashed and have changed state from a liquid to a gas. The first body of homogenous gas mixture exits intermediate pressure 10 at exit 26 and flows through line 28 to the inlet 30 of emissions separator 32. The length of flow line 28 varies from location to location and in most cases, but not always, it is installed above ground. During winter, line 28 may be exposed to low ambient temperatures which could cool the first body of homogenous gas mixture flowing in line 28 to a temperature in which the gaseous liquid hydrocarbons and water vapor contained in the first body of homogenous gas mixture could begin to change state from a gas to a liquid. It is desirable that none of the gases contained in the first body of homogeneous gas mixture change state from a gas to a liquid. The presence of any free water in flow line 28 as a result of water vapor condensing from the first body of homogeneous gas mixture would pose a risk of ice forming in flow line 28 thus blocking the flow in line 28 of the first body of homogeneous gas mixture.

Several types of gas-to-gas heat exchangers can be used to provide heat to the first body of homogenous gas mixture flowing in line 28. The gas-to-gas heat exchangers exchange the heat (e.g., between 225 and 300 degrees Fahrenheit) contained in the hot discharge gas flowing in line 36 with the first body of homogeneous gas mixture flowing in line 28 thus raising the temperature of the gas flowing in line 28.

Both flow lines 28 and 36 may be field installed and connect the vapor processing system to the inlet of inline separator 1 and the outlet of intermediate separator 10 which are in close proximity to each other. One type of heat exchange that may be used is to field lay lines 28 and 36 so that they touch each other, and the two lines are may be insulated with heat resistant insulation. The heat of compression (e.g., 250 to 300 degrees Fahrenheit) from flow line 36 provides heat along the entire length of line 28 to substantially prevent some of the gases contained in the first body of homogenous gas mixture from changing state from a gas to a liquid, and the heat from flow line 36 prevents freezing of any water vapor that might condense in flow line 28.

The first body of homogenous gas mixture flowing in line 28 enters emissions separator 32 at inlet 30. Emissions separator 32 is approximately half full of ethylene glycol (other appropriate liquids or mixture of liquids can also be used). The purpose of the body of ethylene glycol contained in emissions separator 32 is described below. The first body of homogeneous gas mixture entering emissions separator 32 from intermediate pressure separator 10 mixes with the higher BTU fourth body of homogeneous gas mixture collected from the tanks and forms a second body of homogenous gas mixture (collection of the tank gases is described below). Any liquids that might condense from the collected second body of homogeneous gas mixture will separate from the gas and be dumped through motor valve 46 (motor valve 46 is controlled by a liquid level controller (not shown)) and flow line 48 into storage tank 24. The collected second body of homogeneous gas mixture exits emissions separator 32 at outlet 38. The collected second body of homogeneous gas mixture at approximately 27 psig flows through lines 41 and 40 to the suction 42 of reciprocating compressor 34. Reciprocating compressor 34 compresses the collected gases up to a pressure range of, for example, approximately 125 to 250 psig. The discharge pressure of reciprocating compressor 34 is determined by the pressure of the flowing gas stream contained in inline separator 1. From the discharge port 44 of reciprocating compressor 34, the collected second body of homogeneous gas mixture flows through line 71 to point 72. At point 72, line 71 divides to form lines 74 and 36. Line 74 terminates at pressure regulator 76. Pressure regulator 76 is set at approximately 27 psig to maintain a near-to-constant suction pressure at suction port 42 of reciprocating compressor 34. Compressor 34 is sized to compress more gas than the volume of gas entering line 40 from emissions separator 32. Any time the suction pressure at suction port 42 drops below the set point of pressure regulator 76, gas flows from pressure regulator 76 through line 78 to inlet 79 on emissions separator 32 to maintain a near-to-constant pressure at suction port 42. From point 72, the collected second body of homogeneous gas mixture flows through line 36 to point 142. From point 142, the second body of homogeneous gas mixture flows through line 3 to the inlet 2 of inline separator 1. In inline separator 1, the collected higher BTU second body of homogeneous gas mixture from line 36 mixes with the larger volume lower BTU gases flowing through inline separator 1 and forms a third body of homogeneous gas mixture.

Referring again to FIG. 1, and as previously described herein, the liquid hydrocarbons, from intermediate pressure separator 10 flow through motor valve 88 and line 20 and enter storage tank 24 at inlet 22. The liquids from separator 10 flash to form a fourth body of homogenous gas mixture as a result of the pressure change from the pressure in intermediate separator 10 to the near or atmospheric pressure in storage tank 24. In addition to the immediate flash, the liquid hydrocarbons contained in tank 24 continue to evolve gases as the liquid hydrocarbons attempt to reach equilibrium with the gases contained in tank 24. The fourth body of homogenous gas mixture of flash and evolved gases exit storage tank 24 at outlet 50. The fourth body of homogeneous gas mixture from storage tank 24 flows through lines 51, back pressure regulator 53, line 52, line 55, and line 57 to the vacuum inlet 54 of eductor 56.

Eductor 56 is powered by ethylene glycol or other appropriate fluid that is pumped from emissions separator 32 by circulation pump 58. The ethylene glycol exits emissions separator 32 at fluid outlet 60. The ethylene glycol (at, for example, approximately 27 psig) flows through line 64 to suction inlet 62 of circulation pump 58. Circulation pump 58 increases the pressure of the ethylene glycol to approximately 120 psig. The pressurized ethylene glycol exits circulation pump 58 at discharge port 66 and flows through line 68 to power port 61 of eductor 56. While flowing through eductor 56, the pressurized ethylene glycol powers eductor 56 to create a vacuum at vacuum port 54. The vacuum generated by eductor 56 is controlled to a few inches of water column (e.g., 3 to 12 inches) by a vacuum controller such as, for example, a model 12 PDSC supplied by Kimray, Inc. Vacuum controller 82 is connected to line 52 at point 81. Vacuum controller 82 outputs a throttling pressure signal to normally opened motor valve 88. Normally opened motor valve 88 is installed at the termination of line 86. Line 86 begins at point 84 at the end of line 41 and terminates at the inlet of normally opened motor valve 88. Normally opened motor valve 88 is connected by line 90 to line 55 at point 92. When the vacuum at point 81 exceeds the set point of vacuum controller 82, vacuum controller 82 decreases the output pressure to normally open motor valve 88. The decrease of output pressure to normally opened motor valve 88 causes normally opened motor valve 88 to partially open thereby increasing the flow of gas from emissions separator 32 through line 86, motor valve 88, and line 90 into line 55. Increasing or decreasing the volume of gas flowing from emissions separator 32 to vacuum port 54 of eductor 56 maintains the desired vacuum in line 52.

The fourth body of homogeneous gas mixture from storage tank 24 is drawn into eductor 56 through line 51, back-pressure regulator 53, line 52, line 55, and line 57 by the vacuum created by eductor 56. To prevent air entering the system, back-pressure regulator 53 holds a positive pressure of approximately 8 ounces on tank 24. The collected fourth body of homogenous gas mixture is drawn into eductor 56 through vacuum port 54 and is entrained into the flowing ethylene glycol and compressed to a pressure of, for example, approximately 27 psig contained in emissions separator 32. The ethylene glycol and the entrained and compressed fourth body of homogenous gas mixture exit eductor 56 at port 68 and flow through line 70 to inlet 72 of emissions separator 32. In emissions separator 32, as previously described, the collected fourth body of homogenous gas mixture from storage tank 24 mixes with the first body of homogenous gas mixture from intermediate pressure separator 10 and forms a second body of homogeneous gas mixture. The ethylene glycol separates from the entrained gases and falls toward the bottom of emissions separator 32. The ethylene glycol discharged by eductor 56 joins the body of ethylene glycol contained in the approximate bottom two-thirds of emissions separator 32. The ethylene glycol is continuously circulated in a closed loop by circulation pump 62 to provide power to eductor 56.

Heat is generated by the pumping of the ethylene glycol as well as the compression of the collected gases. It is desirable to control the temperature of the ethylene glycol to, for example, between approximately 100 and 120 degrees Fahrenheit. Forced draft cooler 101 provides cooling for the ethylene glycol. Forced draft cooler 101 is connected to circulating pump 58 discharge line 68 at point 94. Line 96, hand valve 98, line 97, thermostatically controlled mixing valve 102, and line 100 connect inlet 99 of forced draft cooler 101 to point 94. Outlet 103 of forced draft cooler 101 is connected by line 105 and line 104 to emissions separator 32 at point 106.

A side stream of ethylene glycol under pressure from circulating pump 58 flows through forced draft cooler 101 and returns to emissions separator 32 thus cooling the ethylene glycol. The volume of ethylene glycol (e.g., 3 to 6 gallons per minute) flowing in the side stream is controlled by adjusting hand valve 98. To maintain the desired temperature of the ethylene glycol of between 100 and 120 degrees Fahrenheit, thermostatically controlled mixing valve 102 can bypass through line 107 a part of, or the entire side stream of, ethylene glycol. Whenever the ethylene glycol becomes too cold, thermostatically controlled mixing valve 102 reduces the volume of the side stream flowing through forced draft cooler 101.

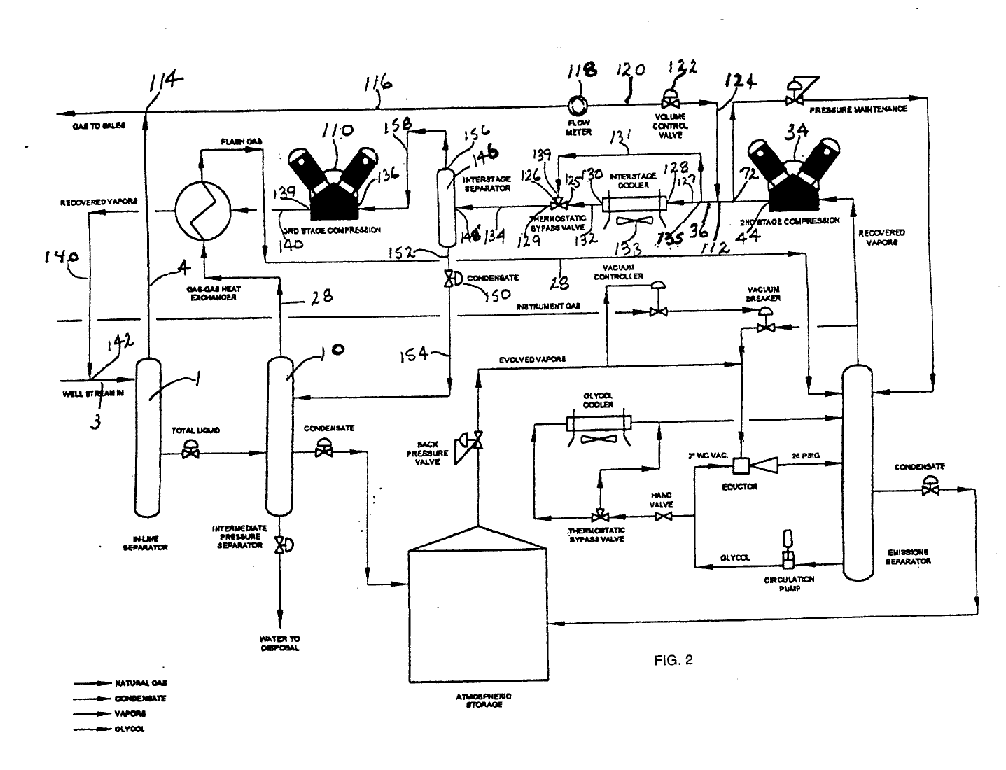

FIG. 2 is a flow diagram of the embodiment wherein the temperature between stages of compression of the homogenous gas mixture is controlled to maintain the suction temperature of each stage of compression. As noted above, the embodiment shown in FIG. 2 is intended for applications where the flowing gas pressure is elevated to pressures above, for example, 250 psig and where the changing of liquid hydrocarbon vapors back from a gas to a liquid state creates recycle loops.

All of the components described in FIG. 1 are incorporated into FIG. 2 and only the components of FIG. 1 required to explain the modifications shown in FIG. 2 are described detail below.

As shown in FIG. 2, a third stage of compressor 110 is added to receive the discharge gas from second stage compressor 34. The hot (e.g., 225 to 300 degrees Fahrenheit), compressed, and collected second body of homogeneous gas mixture exits compressor 34 at discharge port 44 and flows to point 72. From point 72, the hot, compressed, and collected second body of homogeneous gas mixture flows through line 36 to point 112 where a side stream of sales gas from inline separator 1 enters line 36 and mixes with the hot, compressed, collected second body of homogenous gas mixture forming a fifth body of homogeneous gas mixture. The volume of gas from inline separator 1 that enters line 36 at point 112 increases the total volume of gas passing through point 112 by approximately 5% to 10%. The side stream of gas flows from inline separator 1 through line 4 to point 114. From point 114, the side stream of gas flows through line 116, flow meter 118, line 120, flow control valve 122, and line 124 to point 112. Flow control valve 122 is controlled by a PLC or other flow control device (not shown) to allow the required volume of side stream gas from inline separator 1 to increase the volume of gas flowing through point 112 by, for example, approximately 5% to 10%.

As described above, mixing a lower BTU and vapor pressure gas with a higher BTU and vapor pressure gas reduces the tendency of some of the components of the higher BTU gas to change state from a gas to a liquid thereby reducing the chance of recycle loops forming.

From point 112, the fifth body of hot homogeneous gas mixture flows through line 127 to inlet 128 of forced draft cooler 133. While flowing through forced draft cooler 133 the gases are cooled to an approximately 20 degrees Fahrenheit approach to ambient temperature. The cooled gases exit forced draft cooler 133 at outlet 130 and flow through line 132 to cool gas inlet port 125 of thermostatic bypass valve 126. Thermostatic bypass valve 126 monitors the temperature of the gas flowing out of outlet 129 into line 134. When the gas temperature exiting outlet port 129 of thermostatic bypass valve 126 drops to approximately 120 degrees Fahrenheit, thermostatic bypass valve 126 begins to bypass some of the hot gas around cooler 133. The hot gas flows from point 135 through bypass line 131 to hot gas inlet port 139 of thermostatic bypass valve 126. The hot gas from hot gas inlet port 139 mixes in thermostatic bypass valve 126 with the cooled gas from cool gas inlet port 125 thereby maintaining the gas temperature in line 134 at approximately 120 degrees Fahrenheit. Keeping the gas in line 134 at approximately 120 degrees Fahrenheit prevents most of the liquid hydrocarbon condensation that might occur at a cooler temperature in line 134 or separator 146.

The approximately 120 degrees Fahrenheit temperature fifth body of homogeneous gas mixture enters separator 146 at inlet 148. Separator 146 removes any liquids that may have resulted from a phase change from a gas to liquid after the fifth body of homogenous gas mixture is compressed and cooled. The liquids separated in separator 146 are dumped by motor valve 150 (motor valve 150 is actuated by a liquid level controller not shown) through lines 152 and 154 into intermediate pressure separator 10. As described above, some of the gases and liquids contained in the liquid from separator 146 will flash. The balance of the liquids from separator 146 will drop to the bottom of intermediate pressure separator 10 and mix with the liquids from inline separator 1. The overall operation of intermediate separator 10 has been described above.

The fifth body of homogenous gas mixture in separator 146 exits at outlet 156 of separator 146 and flows through line 158 to enter third stage compressor 110 at suction port 136. Third stage compressor 110 compresses the fifth body of homogenous gas mixture to the pressure of the flowing gas stream. From discharge port 139 of third stage compressor 110, the gas flows through line 140 (as previously described, line 140 is installed to be in heat exchange relationship with line 28 from intermediate pressure separator 10) to point 142. At point 142, the fifth body of homogenous gas mixture enters line 3 and mixes with the flowing gas stream to form, in inline separator 1, the previously described third body of homogeneous gas mixture. The function of inline separator 1, as well as the function of the rest of the process, has been described above.

The embodiments described herein have been shown utilizing only three stages of compression (the eductor and two stages of compression). However, it should be understood that other embodiments of the present invention can incorporate more than three stages of compression. Also, it should be understood that mixing gases of different BTU's in relation to each other (i.e., a lower BTU gas with a higher BTU gas such as a lower molecular gas such as methane with a higher molecular weight gas such as butane) can be done between any stage of compression (or at any point in the system). Thus, such a mixing of gases can be performed between the first and second stages and/or between the second and third stages of compression shown in FIG. 2.

There is the potential in cold climates of gas hydrates forming in volume control valve 122 and motor valve 150 (hydrates are an ice-like substance that can form from natural gas when the proper temperature, pressure, and water content are present). Where needed, the potential of hydrates forming in the system can be eliminated by installing a gas-to-gas heat exchanger upstream of volume control valve 122 and a gas-to-liquid heat exchanger upstream of motor valve 150. The hot gas for both exchangers can be the hot discharge gas from compressor 34.

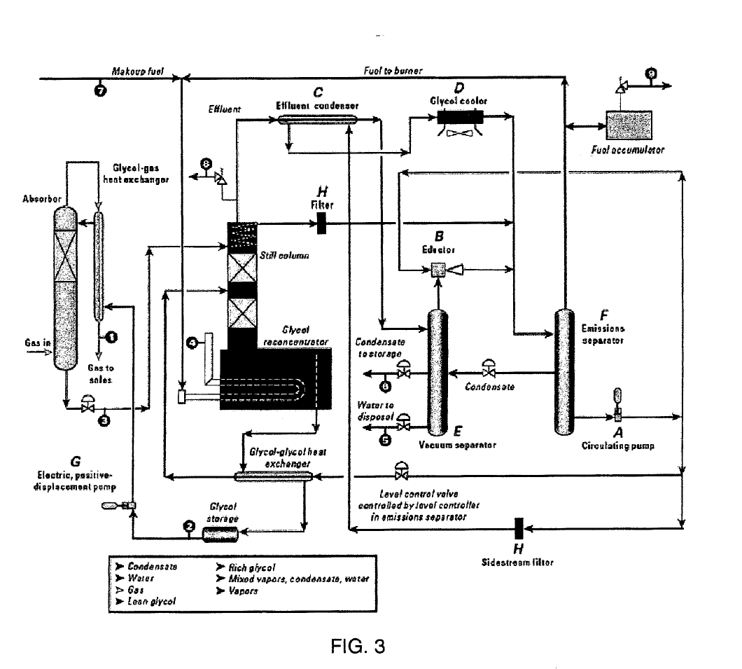

In another embodiment of the present invention, the Vapor Recovery Process System (“VRSA”) described above is combined with natural gas dehydrations systems and methods such as that described in U.S. Pat. No. 6,984,257, titled “Natural Gas Dehydrator and System” (to the inventor herein), the specification and claims of which are incorporated herein by reference, and which are referred to herein as “QLT”, to provide a combination QLT/VRSA unit. FIG. 3 shows such a natural gas dehydration system (“QLT”) that may be combined with the VRSA. By combining the two technologies into a common unit, many of the features, which have commonality in both technologies, are used to reduce the manufacturing costs of a combination QLT/VRSA unit as well as reducing installation and operating costs. The combination QLT/VRSA unit further comprises improvements that enhance the performance of both technologies. Although the description that follows is illustrative of a retrofit unit, the combination QLT/VRSA unit could also be provided in combination with a natural gas dehydrator.

Preferably, most of the operating features/components of the QLT and VRSA would be utilized in the combination QLT/VRSA unit. Because the majority of applications for the combination QLT/VRSA unit are at non-electrified well sites, the following description is of a well site application where commercial electricity is not available, although the present invention is applicable to well sites having electric service.

Non-electrified well sites require either an engine generator to provide electric power to run the pumps and compressor required to operate the QLT and VRSA or else the pumps and compressor can be direct belt driven from a common shaft powered by an engine. Because of the possible explosive factor present when using electricity, direct driving the pumps and compressor is a better choice for non-electrified well site applications of the QLT and VRSA.

Some of the commonality that exists between the QLT and VRSA are obvious. Both technologies use a natural gas fueled engine to provide unit operating power. In the combination QLT/VRSA unit, only one engine is required. Both technologies use eductors to create a vacuum and compress collected vapors. Both technologies utilize a high volume circulating pump to circulate glycol to provide the energy to power the eductor. In the combination QLT/VRSA unit, only one high volume circulating pump is required. Both units require a house and skid. Both units require an emissions separator. In the combination QLT/VRSA unit, only one emissions separator is used to receive the rich glycol from the dehydrator absorber. The rich glycol from the dehydrator absorber is circulated by a high volume pump through two eductors, one for the VRSA and one for the QLT. Using the rich glycol from the dehydrator absorber to power the VRSA eductor eliminates the necessity for providing glycol for the original glycol fill of the VRSA emissions separator, eliminates the need for heating the glycol in the VRSA emissions separator, eliminates the concern for ever having to replenish the glycol in the VRSA emissions separator, and eliminates any concern that the glycol in the VRSA emissions separator would ever become saturated with water or hydrocarbons. Other commonalities and improved process functions will become apparent as the design and operation of the combination QLT/VRSA unit is further described below.

As noted above, an embodiment provides that two eductors be used in the combination unit. One eductor is used to provide the vacuum to collect and compress the vapors from the gas well's(s') fluid production, and the other eductor is used to provide the vacuum to collect and compress the emissions from the dehydrator or dehydrators located at the well site.

Two eductors allow both the VRSA and OLT to be operated at the most desirable vacuum for the process. Because a back-pressure regulator is used in the VRSA system to hold a minimum of 4 ounces on the storage tank, the vacuum on the VRSA system is operated at a higher level than the vacuum on the OLT system. On most dehydrators that would be retrofitted with the QLT, the reboiler operates at atmospheric pressure, and any vacuum applied to the reboiler raises the glycol level in the reboiler. The specific gravity of glycol compared to water is approximately 1.1; therefore, each one inch water column vacuum raises the glycol level in the reboiler approximately 0.9 inches. Reboilers are generally designed to operate substantially full of glycol, and any excess or uncontrolled vacuum can cause glycol overfill conditions in the reboiler. The OLT is designed to operate at 2 to 3 inches water column vacuum.

Using two eductors in the combination unit requires that two vacuum separators be used—one for the VRSA and one for the OLT. The vacuum separator for the VRSA is two-phased—the first phase is uncondensed hydrocarbon vapors, and the second phase is condensed hydrocarbon liquids. The uncondensed hydrocarbon vapors under a vacuum in the VRSA vacuum separator are pulled into the VRSA eductor and compressed into a common emissions separator. The condensed hydrocarbon liquids under a vacuum are collected in the bottom of the VRSA vacuum separator and dumped back to the storage tanks. It should be again noted that the VRSA eductor is powered by rich glycol generated by the dehydration process. The vacuum separator for the OLT is a three-phased and operates the same as the three-phased vacuum separator previously described in, for example, U.S. Pat. No. 6,984,257, and the QLT eductor also operates the same as described in, for example, U.S. Pat. No. 6,984,257. The uncondensed hydrocarbon vapors from the QLT vacuum separator are collected and compressed into the common emissions separator to form a homogeneous mixture with the hydrocarbons collected from the VRSA vacuum separator.

Sizing of the VRSA eductor is complicated by the fact that hydrocarbon liquid production from gas wells is seldom constant. Generally, the volume of liquid hydrocarbons flowing to the storage tanks is erratic, and many times the volume of liquid hydrocarbons flowing to the storage tanks is produced in slugs. Because the production of liquid hydrocarbons from gas wells is seldom constant, the hydrocarbon vapor load on the combination VRSA eductor is constantly changing, and sometimes the hydrocarbon vapor load can, and will, overload the capacity of the VRSA eductor.

Sizing of the QLT eductor is not as complicated as the sizing for the VRSA eductor. On a dehydrator, the glycol circulation rate is fairly constant, and other conditions, such as gas temperature or changes in dehydrator operating pressure do not generally occur rapidly or of a magnitude to significantly affect the uncondensed vapor load on the QLT eductor. In all cases, the QLT eductor is sized to have excess capacity to handle any expected uncondensed vapor load that might occur from the dehydration process. In the combination unit, any available excess capacity of the QLT eductor can be utilized to increase the capacity of the VRSA eductor. An overload condition of the VRSA eductor occurs when the VRSA vacuum separator experiences a positive pressure condition approaching the 4 ounce positive pressure setting of the tank vent line back-pressure regulator. As the positive pressure in the VRSA vacuum separator approaches 4 ounces, a valve in a line between the VRSA and QLT vacuum separators opens thus allowing excess uncondensed hydrocarbon vapors in the VRSA vacuum separator to begin flowing into the QLT vacuum separator. The volume of uncondensed hydrocarbon vapors flowing from the VRSA to the QLT vacuum separator is controlled so that the total volume of uncondensed hydrocarbon vapors entering the QLT vacuum separator does not exceed the capacity of the QLT eductor.

Combining the VRSA technology into other production equipment such as a production unit, a standard dehydrator, or a QLT equipped dehydrator creates a potential well site installation problem. Because of safety concerns, the liquid hydrocarbon storage tanks are located on the well site at a considerable distance (100 to 200 ft) from any piece of well site production equipment that is direct fired. Ordinarily, the VRSA is installed in close proximity to the storage tanks. By installing the VRSA close to the storage tanks, the tanks' vent line can be sloped from the top of the tank to the inlet connection on the VRSA. Sloping the tanks' vent line prevents any condensed hydrocarbon liquids from collecting in the tanks' vent line and creating a liquid seal to block the flow of the hydrocarbon vapors from the tanks to the VRSA.

Because the retrofit combination QLT/VRSA unit is installed in close proximity to the well site direct fired dehydrator, the VRSA portion of the combined unit is located a considerable distance from the liquid hydrocarbon storage tanks. It would be impractical and costly to suspend in the air the tanks' vent line from the top of the tanks to the VRSA inlet of the combination unit. Therefore, connecting the combination VRSA inlet to the top of the storage tanks is preferably by going directly down from the top of the tanks to below ground level and running the vent line underground to connect from underground into the inlet of the combination VRSA.

Running the storage tanks' vent line underground from the tanks to the VRSA solves all the problems with the tank vent line except for the problem of creating a condensed liquid trap which would form a liquid seal to stop the flow of vapors from the storage tanks to the VRSA. To eliminate the fluid trap, the following is installed as part of the combination unit. A vertical fluid collection pot, preferably approximately two feet long and four inches in diameter, is installed underground where the tank vent line ends and the bottom of a preferably vertical two inch diameter riser pipe connected to the VRSA inlet begins. The VRSA inlet includes the back-pressure regulator that maintains a positive pressure (approximately 4 ounces) on the storage tanks. The vertical riser pipe connects to the VRSA inlet upstream of the back-pressure regulator. The tanks' vent line is installed so that there is a gradual slope from the tanks to the VRSA unit. The tank vent line, generally an approximately two inch diameter pipe, connects to the side near the top of the vertical fluid collection pot. The bottom of the vertical riser pipe connected to the VRSA inlet connects to the top of the vertical fluid collection pot. A ½ inch diameter pipe is installed inside the two inch vertical riser pipe which is connected between the top of the fluid collection pot and the VRSA inlet. The bottom end of the ½ inch diameter pipe terminates approximately 1 inch above the bottom of the fluid collection pot. The top of the ½ pipe turns horizontal and exits the vertical two inch riser pipe through the side approximately one foot below where the vertical two inch riser pipe connects to the VRSA inlet. The horizontal top outlet of the ½ inch pipe connects to the vacuum port of a ½ inch eductor such as a Penberthy model ½ALH. A side stream of rich glycol (approximately 2 gallons/minute) from the common emissions separator circulates under pressure from the circulation pump of the combination unit to the power port of the ½ inch eductor. The outlet of the ½ inch eductor connects to the common emissions separator at approximately the same level as the connections for the QLT and VRSA eductors.

In operation, hydrocarbon liquids condensed from the vapors collect in the tanks' sloped vent line and flow along the bottom of the sloped vent line into the vertical fluid collection pot. The ½ inch eductor continually lifts the condensed hydrocarbon liquids through the ½ inch line inside the riser pipe and sends the condensed hydrocarbon liquids under pressure into the common emissions separator. The common emissions separator collects the condensed hydrocarbon liquids and dumps them back to the storage tanks. During those times when the capacity of the ½ inch eductor is not being required to lift condensed hydrocarbon liquids, the ½ eductor slightly increases the vacuum capacity (approximately 16 cubic feet per hour) of the VRSA.

As noted above, the vertical riser pipe connected to the top of the fluid collection pot is connected to the VRSA inlet upstream of the tank vent line back-pressure valve. Because the ½ inch eductor is lifting fluids and possibly pulling a vacuum on the tanks vent line upstream of the vent line back-pressure valve, under conditions of no or little fluid production to the tanks, the ½ eductor could lower the positive pressure on the tanks and possibly create a vacuum on the tanks. To prevent any possibility that the ½ inch eductor could create a vacuum condition on the tanks an ounces regulator is installed in a line running between the common emissions separator and the vertical riser pipe. The inlet of the line containing the ounces regulator is connected to the common emissions separator in the vapor chamber close to the top. The outlet of the line containing the ounces regulator is connected to the riser pipe upstream of the vent line back-pressure regulator.

In operation, the ounces regulator is set to maintain a pressure in the tanks' vent line slightly less then the pressure setting of the vent line back-pressure regulator. As long as the pressure on the vent line is above the setting of the ounces regulator, no vapors feed from the emissions separator into the tanks vent line; however, if conditions ever exist where a vacuum induced by the ½ inch eductor lowers the pressure in the tanks vent line enough to reach the set pressure of the ounces regulator, the ounces regulator would feed hydrocarbon vapors from the common emissions separator into the tanks' vent line to maintain a positive vent line pressure equal to the ounces regulator setting. By using collected vapors from the common emissions separator to maintain the positive pressure on the tanks' vent line, no additional hydrocarbon vapors are introduced into the system.

It should be noted that the fluid pumping system described above may be used on any type of unit where the VRSA technology is combined with a piece of equipment that requires the combined unit to be installed a distance from the hydrocarbon storage tanks. On stand alone VRSA units where the tank vent line can be installed allowing the line to be sloped from the top of the tank to the VRSA inlet, the fluid pumping system is not required.

The application of the stand alone VRSA as well as combination units designed to utilize the VRSA technology will be increased by the move, on shore, to directionally drill multiple gas wells from a common well pad. Having multiple gas wells producing from a common well pad increases the volume of recovered hydrocarbon liquids at the well pad which, in turn, improves the economics of installing a VRSA. The economics of installing a VRSA on multiple gas wells are improved because one VRSA can be utilized to recover the venting from all the hydrocarbon storage tanks located on the well pad. It follows that the economics of installing, on a multiple well pad, a QLT or a combination OLT/VRSA unit would be improved by designing the QLT or combination QLT/VRSA unit so that one QLT unit can be utilized to collect all the venting that occurs from multiple dehydrators on the well pad.

Thus, in an embodiment, one combination QLT/VRSA unit is used to collect all the hydrocarbons that are vented to the atmosphere by multiple dehydrators and multiple hydrocarbon storage tanks located on one well pad. The one combination QLT/VRSA unit turns the well pad into an emissions free location with all recovered hydrocarbons either being used for fuel gas or sold to produce increased revenues. As previously noted, no design change or concept is required for one VRSA to collect the storage tank vapors from multiple wells on a common well pad. The OLT requires some minor design and conceptual changes for one QLT to recover the hydrocarbon venting from multiple dehydrators on a well pad.

On a multiple well pad with no commercial electricity, “one” dehydrator on the multiple well pad would operate with a natural gas fueled engine direct driving the circulation pump and positive displacement pump needed to power the VRSA and all other dehydrators. The balance of the OLT system on the “one” dehydrator would be larger. Each additional dehydrator on the well pad operates as follows. To eliminate the gas which is normally vented by, for example, a Kimray glycol pump, the Kimray glycol pump is powered by rich glycol from the emissions separator which is part of the QLT system for the “one” dehydrator. The rich glycol is pressurized by a positive displacement pump to a pressure adequate to power the Kimray pumps on the additional dehydrators. One or more positive displacement pumps are used to provide the pressurized rich glycol required to run the additional Kimray glycol pumps. After providing power to run the additional Kimray glycol pumps, the rich glycol is returned to the emissions separator which is part of the “one” dehydrator QLT system. It should be noted that on some applications of the combination QLT/VRSA unit, depending upon the absorbers operating pressure, it is possible to operate the Kimray glycol pumps the way they are designed to be used (using the rich glycol exiting the absorbers to power the pumps). If the application should allow the Kimray glycol pumps to be powered by the rich glycol exiting the absorber, the excess gas generated by the Kimray glycol pumps would be routed to the first stage of the VRSA gas compressor to be compressed to sales pressure along with collected vapors.

On all additional dehydrators on a common well pad where the Kimray pumps are being driven with rich glycol with the energy being supplied by a direct driven positive displacement pump, a dump pot must be installed, and, if a three-phased flash separator is not already on the dehydrator skid, in the preferred design, a three-phased flash separator must be installed. The dump pot is necessary for the process to function. The three-phased flash separator is preferably, but not absolutely necessary, for the process to function. In the preferred design, the dump pot receives the rich glycol from the absorber and dumps the rich glycol to a flash separator. The flash separator operates at a pressure higher then the first stage of the VRSA gas compressor. When the pressure in the three-phased flash separator reaches the pressure set point, uncondensed gases released from the rich glycol exiting the absorber flow to the first stage of the VRSA gas compressor to be compressed to sales pressure along with collected vapors. Any liquid hydrocarbons in the rich glycol exiting the absorber are collected in the three-phased flash separator and dumped to the hydrocarbon storage tanks. As in the normal dehydration process and before the dump pot is installed, the rich glycol entering the three-phased flash separator from the absorber is dumped from the three-phased flash separator to flow through the same glycol path as taken by the rich glycol when the rich glycol exited the Kimray glycol pump after being used to drive the pump.

The still column effluents from each additional dehydrator on a well pad are collected by connecting the still columns of each additional dehydrator to the effluent condenser inlet on the “one” dehydrator QLT system. The vacuum being generated by the eductor on the “one” dehydrator QLT system provides the energy to move the additional still column effluents to the inlet of the condenser. On some dehydrators, a still column effluent condenser is provided. Where a usable still column effluent condenser is provided on a dehydrator to be retrofitted, the uncondensed vapors from the effluent condenser are collected by connecting the vacuum generated by the “one” dehydrator eductor to the outlet of the retrofitted dehydrators' effluent condenser.

In another embodiment, one eductor and one vacuum separator is used in the combination QLT/VRSA unit. This embodiment comprises a vacuum chamber in the top of the emissions separator. One eductor is used to create the vacuum in the vacuum chamber. The VRSA flow line from the outlet of the back-pressure regulator connects directly to the vacuum chamber with all other components and operation of the VRSA remaining the same. The vacuum in the vacuum chamber is preferably maintained at 2 to 3 inches of water column which is enough vacuum for both the QLT and VRSA processes.

A two or three phased liquid accumulation separator is installed in the line connected to the outlet of the dehydrator effluent condenser. The separator collects condensed liquids created by cooling the effluents from the dehydrator still column. The uncondensed gases from the dehydrator effluents flow from the gas outlet of the liquid accumulation separator to the vacuum chamber. The vacuum port of the eductor connects to the vacuum chamber, and the collected uncondensed gases and any unseparated hydrocarbon liquids from the QLT and VRSA processes flow through the eductor and are compressed to approximately 20 to 25 psig in the lower chamber of the emissions separator.

As previously noted, the liquid accumulation separator can be two or three-phased. A three-phased liquid accumulation separator separates the condensed liquids into its hydrocarbon and water components. The hydrocarbons and water are then be dumped to separate storages. A two-phased liquid accumulation separator also separates the condensed liquids into hydrocarbon and water components, but the condensed hydrocarbons are not be dumped directly to storage. Instead, the condensed hydrocarbons flow with the uncondensed gases from the outlet of the liquid accumulation separator and enter into the vacuum chamber. In the vacuum chamber, the condensed hydrocarbons mix with any liquid hydrocarbons from the VRSA process and flow with the collected gases through the vacuum port of the eductor to be compressed into the lower chamber of the emissions separator. The emissions separator is three-phased to separate liquid hydrocarbons from glycol. Any liquid hydrocarbons collected in the emissions separator are dumped to storage by the three-phasing system of the emissions separator.

In one embodiment, the compressor used on the VRSA has an extended cross-head system that connects the crank-shaft to the piston. The extended cross-head system creates a chamber where the connecting rod runs through two sets of packing. The top set of packing prevents the compressed gases from entering the cross-head chamber, and the lower set of packing prevents the compressor oil from entering the cross-head chamber. The cross-head chamber has a tapped and threaded opening to the atmosphere. Any gases or oil that might enter the cross-head chamber are ordinarily released to the environment.

Because the VRSA creates a vacuum, the release of gases or oil from the cross-head chamber to the environment can be prevented by connecting the cross-head chamber to the VRSA vacuum chamber. A simple flow meter is installed in the line connecting the cross-head chamber to the vacuum chamber. Excess flow through the simple flow meter would indicate a problem with either the upper or lower cross-head packing.

Another embodiment of the present invention comprises an engine speed control. At times, it may be necessary or desirable to increase the hydrocarbon vapor handling capacity of the VRSA to prevent hydrocarbon vapors from escaping to the atmosphere when large slugs of hydrocarbon liquids are dumped to the storage tanks. The engine on the present invention runs at a constant speed of, for example, approximately 2600 RPM. The maximum speed of the engine may be 3600 RPM. Thus, for example, the hydrocarbon vapor handling capacity of the present invention could be increased by approximately 40 percent by simply increasing the engine speed when the system begins to experience an over-load condition.

It might also be desirable to slow the engine speed below, for example, 2600 RPM when the VRSA begins to experience an under-load condition. When allowed, slowing the engine speed to approximately 1500 RPM (the engine idle speed) would save engine life and operating fuel and would decrease the possibility of pulling a vacuum on the storage tanks.

Thus, the object of this embodiment comprising the engine speed control is to provide an operating system that can sense over or under operating load conditions and can adjust the engine speed between, for example, approximately 1500 and 3600 RPM to accommodate the system load requirements.

As in the other embodiments described above, the basic components of the invention such as the engine, belt-driven compressor and circulation pump, eductor, and two-chambered (vacuum and pressure) emissions separator would remain the same in this embodiment. For this embodiment, the invention comprises the changes described below to accomplish engine speed control.

A first 12 volt pressure transducer is installed in the pressure chamber of the emissions separator to sense a rise or fall of the gas pressure (preferably in pounds per square inch) in the pressure chamber. The desired gas pressure range in the pressure chamber of the emissions separator is preferably between approximately 20 and 25 psig. A small increase of gas pressure in the pressure chamber causes an increase in the electrical signal from the first 12 volt pressure transducer. A small decrease of gas pressure in the pressure chamber causes a decrease of the electrical signal from the first 12 volt pressure transducer.

A second 12 volt pressure transducer is installed upstream of the ounces back-pressure valve presently installed on the vapor collection line from the storage tank or tanks. The second 12 volt pressure transducer senses a rise (preferably in ounces) of the gas pressure in the collection line. The ounces back-pressure regulator, installed in the vapor collection line from the storage tank or tanks is preferably set to hold from between approximately two to four ounces of gas pressure on the storage tanks. A small increase in the ounces gas pressure above the set point of the ounces back-pressure regulator increases the electrical signal from the second 12 volt pressure transducer.

A programmed computer or “process logic controller” (“PLC”) is installed to receive the electrical signals from both the first and second 12 volt pressure transducers. The PLC is programmed to increase the engine speed to a maximum of preferably approximately 3600 RPM on an increase in the electrical signal from the first 12 volt pressure transducer; or, to decrease the engine speed to a minimum of preferably approximately 1500 RPM on a decrease in the electrical signal from the first 12 volt pressure transducer. The PLC is also programmed to increase the engine speed on an increase in the electrical signal from the second 12 volt pressure transducer. The program logic of the PLC thus allows for the electrical signal from either the first or second 12 volt pressure transducers to control the engine speed depending on which electrical signal is greater. The PLC is also in communication with the circulation pump.

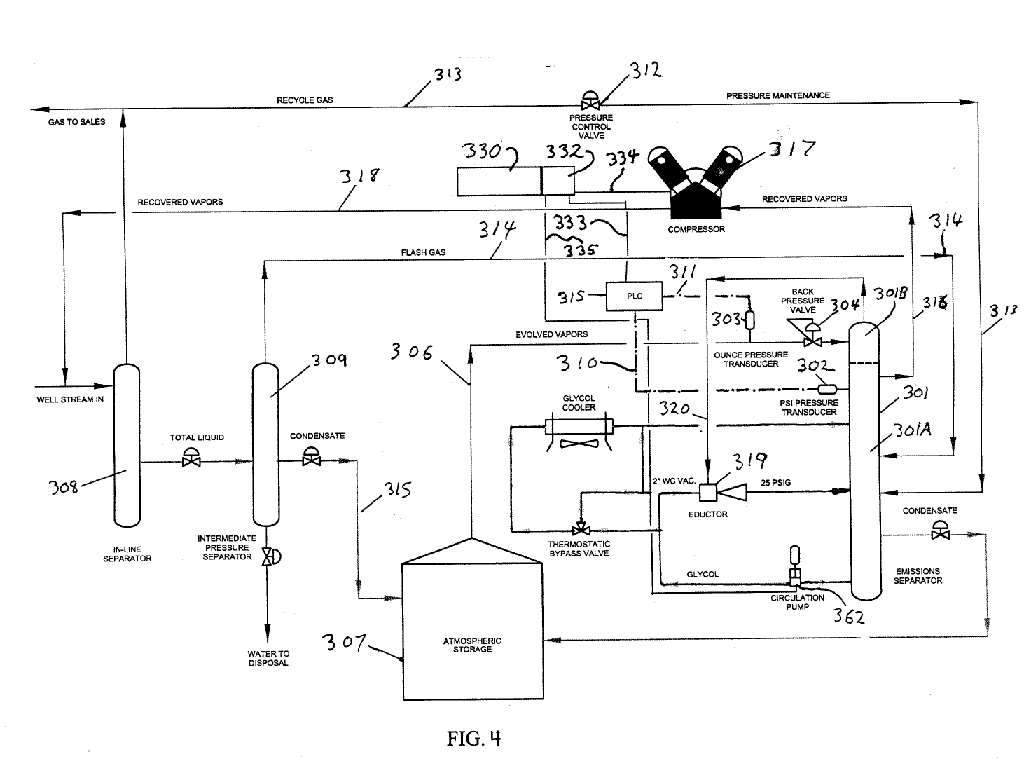

Referring to FIG. 4, a flow diagram is shown illustrating the process of the VRSA incorporating the present embodiment. Emissions separator 301 comprises pressure chamber 301A and vacuum chamber 301B. Pounds first pressure transducer 302 is in communication with pressure chamber 301A. Ounces second pressure transducer 303 is located on storage tank vapor collection line 306 which leads from storage tank 307. Ounces back-pressure valve 304 is located on line 306 between second transducer 303 and vacuum chamber 301B. PLC 305, which is programmed to control the speed of engine 330, is in communication with first transducer 302 via electric line 310, second transducer 303 via electric line 311, compressor 317 via electric line 334, and circulation pump 362 via electric line 335. Engine 330 is preferably in communication with the aforementioned components via electronic governor 332. Production line separator 308 is in communication with storage tank 307 via line 315 on which intermediate pressure 309 is located. Pressure regulator 312 is located on line 313 which brings make-up gas to emissions separator pressure chamber 301A. The pressure of the gas entering pressure chamber 301A from line 313 is regulated by pressure regulator 312 to maintain, at all times, a minimum pressure of approximately 20 PSIG in pressure chamber 301A. Line 314 brings flashed gases from intermediate separator 309 to pressure chamber 301A. Line 315 transfers intermediate pressure hydrocarbon liquids from intermediate pressure separator 309 to storage tank 307. Line 316 is a flow line that transfers all the gases collected in pressure chamber 301A to compressor 317. Flow line 318 transfers all the gases compressed by compressor 317 to the inlet of production line separator 308. Flow line 320 transfers collected tank vapors to the vacuum port of eductor 319.

In this embodiment, the natural gas production stream from the natural gas well or wells enters production line separator 308, and the gas production stream is separated into its gaseous and liquid components. The gaseous components of the natural gas production stream pass out of production line separator 308 for further processing and sale. The liquid components of the natural gas production stream are dumped from production line separator 308 to intermediate pressure separator 309. Separator 309 will generally operate at a pressure of from between approximately 50 and 100 PSIG. The reduction of pressure from separator 308 to separator 309 cause gases to flash from the liquid hydrocarbon stream. The flashed gases flow through line 314 to enter pressure chamber 301A. The flashed gases mix with the gases in pressure chamber 301A as well as mixing with any other gases entering pressure chamber 301A.

The hydrocarbon liquids collected in intermediate pressure separator 309 are dumped from intermediate separator 309 to storage tank 307 via conduit 315 where the pounds of gas pressure reduction from the pressure of intermediate pressure separator 309 to the ounces gas pressure of storage tank 307 cause the hydrocarbon liquids to further flash. The flashed gas from storage tank 307 flows through line 306 and back pressure valve 304 to enter vacuum chamber 301B. From vacuum chamber 301B the collected gas flows through flow line 320 to be compressed by eductor 319 into pressure chamber 301A.

As previously described, all the gases entering pressure chamber 301A are compressed to flowing line pressure by compressor 317 and injected into the natural gas stream flowing from the gas well or wells. As long as the compressor 317 and eductor 319 have the capacity to handle the volume of gases flowing from intermediate separator 309, storage tank 30, and make-up gas line 313, no gases are vented to the atmosphere from tank 307. However, because the volume of hydrocarbon liquids being produced by the gas well(s) can vary several times during the day from no hydrocarbon liquids to a volume of hydrocarbon liquids large enough to generate enough flashed gases to exceed the gas handling capacity of the VRSA embodiments described above, the design of this embodiment must allow for the capacities of compressor 317 and eductor 319 to increase or decrease to accommodate the volume of liquid hydrocarbons being produced by the well(s). As previously described, first and second pressure transducers 302 and 303, while reacting to the gas pressure in pressure chamber 301A and the gas pressure in vapor collection line 306, provide electrical signals to PLC 305 causing PLC 305 to change the speed of engine 330. Changing the speed of engine 330 either increases or decreases the gas handling capacities of both compressor 317 and eductor 319.

The preceding examples can be repeated with similar success by substituting the generically or specifically described compositions, biomaterials, devices and/or operating conditions of this invention for those used in the preceding examples.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above, and of the corresponding application(s), are hereby incorporated by reference.

1. A method for preventing the release of natural gas at a natural gas well processing system from being released to the atmosphere, the method comprising:
collecting evolved gases from a storage tank;
entraining the evolved gases into a fluid stream;
compressing the evolved gases and fluid stream;
sending the evolved gases and fluid stream to an emissions separator; and
separating the gases from the fluid stream for further processing.

2. The method of claim 1 comprising collecting the evolved gases using a vacuum.

3. The method of claim 2 further comprising providing an eductor to create the vacuum and entraining gases into the fluid stream.

4. The method of claim 1 further comprising mixing a first compressed gas with a second compressed gas flowing in a pipeline, the second compressed gas having a BTU lower relative to BTU of the first compressed gas to prevent gaseous hydrocarbons in the natural gas well processing system from entering a fluid state.

5. A method for preventing the release of gaseous hydrocarbons at a natural gas well processing system from entering the atmosphere, the method comprising:
providing an emissions separator:
sending to the emissions separator entrained gases evolving from hydrocarbon fluids are separated from a flowing gas stream at higher pressure and disposed in lower pressure of an intermediate separator:
sending the gaseous hydrocarbons to a compressor and compressing the gaseous hydrocarbons; and
sending the compressed gaseous hydrocarbons to a flowing as stream for further processing or point of sale.

6. A natural gas well processing system comprising:
a hydrocarbon storage tank;
an eductor linked to said storage tank to receive gases that evolve in the storage tank, entrain the gases into a fluid stream and compress the gases and the fluid stream; and
an emissions separator linked to said eductor for receiving the evolved gases and fluid stream for separation of the gases from the fluid stream and for sending the gases out of said emissions separator for further processing.

7. A system for controlling speed of an engine of a natural gas well vapor recovery processing system to increase a vapor handling capacity of the vapor recovery system, said engine speed control system comprising:
an emissions separator comprising a pressure chamber and a vacuum chamber;
a first pressure transducer in communication with said pressure chamber to sense a rise or fall of pressure in said pressure chamber;
a computer in communication with said first pressure transducer and in communication with the engine to vary the engine speed in response to a signal from said first pressure transducer; and
a second pressure transducer located on a vapor collection line between a storage tank and said vacuum chamber, said second pressure transducer sensing a rise in pressure in said vapor collection line, and said second pressure transducer in communication with said computer so that said computer varies the engine speed in response to a signal from said second pressure transducer.
